(19) United States
(12) Patent Application Publication
(10) Pub. No.: US 2015/0356885 A1
(43) Pub. Date: Dec. 10, 2015

(54) METHOD AND APPARATUS FOR GENERATING AND DELIVERING PERSONALIZED NUTRITION

(71) Applicants: Theodore C. CHEN, Los Altos, CA (US); James W. ROSE, Menlo Park, CA (US)

(72) Inventors: Theodore C. CHEN, Los Altos, CA (US); James W. ROSE, Menlo Park, CA (US)

(21) Appl. No.: 14/730,660

(22) Filed: Jun. 4, 2015

Related U.S. Application Data
(60) Provisional application No. 62/009,068, filed on Jun. 6, 2014.
(60) Provisional application No. 62/020,679, filed on Jul. 3, 2014.

(51) Int. Cl. G09B 19/00; A23L 1/302; A23L 1/30; B01F 15/02; A23L 1/305; B01F 15/00; B01F 13/00; A23L 1/29; A23L 1/304

(52) U.S. Cl. CPC G09B 19/0092; A23L 1/296; A23L 1/302; A23L 1/30; A23L 1/304; A23L 1/305; B01F 15/00311; B01F 13/0016; B01F 15/0216; A23V 2002/00

(57) ABSTRACT

Determining and delivering personalized nutrition to individuals by generating a personalized nutrition plan for an individual that specifies at least one dosage formula including specific amounts of a plurality of nutritional ingredients. Once the dosage formula is defined, the ingredients are physically delivered to the individual and the dosage formula is delivered over an electronic communication network to a nutrition appliance associated with the individual. The nutrition appliance is configured to generate a food product from (a) the plurality of nutritional ingredients provided to the individual and (b) in accordance with the dosage formula delivered over the electronic communication network. In a non-exclusive embodiment, the dosage formula includes specified amounts of at least vitamins, antioxidants, proteins and carbohydrates and a flavor. The food product may be either a liquid, such as a beverage and smoothie, or a solid, such as a bar, cereal, cracker or chip.

### CROSS REFERENCE TO RELATED APPLICATIONS

This application claims the benefit under 35 U.S.C. 119(e) of U.S. Provisional Application No. 62/009,068 entitled “METHOD AND APPARATUS FOR PROVIDING PERSONALIZED NUTRITION” filed Jun. 6, 2014; and U.S. Provisional Application No. 62/020,679 entitled “METHOD AND APPARATUS FOR GENERATING AND DELIVERING PERSONALIZED NUTRITION” filed Jul. 3, 2014, both of which are incorporated herein by reference for all purposes.

### BACKGROUND

1. Field of the Invention

This invention relates to nutrition, and more particularly, to a method and apparatus for determining and delivering personalized nutrition to individuals.

2. Description of Related Art

Currently personal nutrition is provided and delivered in an ad-hoc manner. For some individuals, personalized nutrition involves self-researching the topic through a variety of sources, such as online, through books, magazines and/or periodicals, defining on their own diet and nutritional ingredients, and then purchasing these items from either local markets and/or from online retailers. For others, personalized nutrition involves consulting with a professional nutritionist, who typically will generate a customized diet and a list of other nutrition ingredients, based on the personal situation and objectives of the client. The client, however, is still required to purchase some or all of the recommended items on their own, again, typically through local markets, online retailers or possibly directly from the nutritionist. More recently, DNA tests for nutrition have become popular. With these tests, an individual is required to provide a DNA sample, such as saliva, to a lab for testing. Based on the DNA results, in addition to other meta-analysis, a customized formula of nutritional ingredients, tailored to the individual may be created.

In recent years, the field of sports nutrition has become extremely popular and sophisticated. Besides training, more and more athletes are resorting to a personalized nutrition plan of select ingredients to achieve more energy, increased speed, strength, endurance, lose fat, and either increased or decreased muscle mass, whichever is preferred or desired. In many instances, the nutrition plan of an athlete provides a competitive advantage, resulting in the athlete achieving personal bests, winning competitions, and/or competing at higher levels or competition. Many professional athletes and sport teams have concluded that personalized nutrition is often the major factor between winning and losing a competition among athletes/teams with otherwise comparable skill and training levels. Again, however, the delivery of sports nutrition, including nutrition ingredients, is typically administered on an ad-hoc basis. Both amateur and professional athletes typically have to conduct their own nutritional research and/or rely on sport-nutrition experts for help. Regardless of the level, athletes are still usually required to seek out and purchase their own food and/or ingredients from either local or online merchants.

With the Internet, online sports and fitness communities have become very popular, for example, web sites such as “Fitbit” and “Strava”. With these web sites, members can share tips and other information about their sport(s), track their performance metrics, and compare their performance versus others. In these web communities, however, only general nutritional information is provided. To the knowledge of the applicants, no such sports and/or fitness related website is currently available that determines and delivers personalized nutrition services to individuals.

### SUMMARY OF THE INVENTION

The aforementioned problems are solved by a method and system for determining and delivering personalized nutrition to individuals.

In one non-exclusive embodiment, a system and method involves: (i) generating a personalized nutrition plan for a individual including at least one dosage formula that specifies amounts of a plurality of nutritional ingredients. Once the dosage formula is defined, the system and method further involves (ii) delivering the nutritional ingredients to a nutrition appliance and (iii) delivering the dosage formula over an electronic communication network to the nutrition appliance. The method further involves (iv) configuring the nutrition appliance to generate a flavored food product from (a) the plurality of nutritional ingredients provided to the individual and (b) in accordance with the dosage formula delivered over the electronic communication network. In a non-exclusive embodiment, the dosage formula includes specified amounts of nutritional ingredients such as but not limited to vitamins, antioxidants, proteins, carbohydrates, minerals, extracts, electrolytes, energy supplements, and one or more flavor additive(s). In addition, the food product may be either a liquid, such as a beverage, juice, and smoothie, or a solid, such as a bar, cereal, cracker or chip.

In various alternative embodiments, the personalized nutrition plan specifies multiple dosage formulas, all of which are provided to the nutrition appliance over the electronic communication network. Each of the multiple dosage formulas results in a food product having a different composition of the nutritional ingredients. In one embodiment, each food product composition is optimized and intended for consumption by the individual at a predetermined time of day, such as for example, a morning wake-up formula, an afternoon pick-me-up formula, and an relax/unwind formula in the evening before bed-time. In yet another alternative embodiment, each food product composition is optimized and intended for consumption by the individual in anticipation of a specific activity. Such activities may include, but are not limited to, training for a sport, just before participation in a sporting event, during the sporting event and in recovery following the sporting event. In yet other alternative embodiments, each formula may be optimized for a meal, such as breakfast, lunch, dinner, between meal snacks, etc.

In a non-exclusive embodiment, the delivering of the dosage formula involves establishing a communication session between a server and the nutrition appliance over the communication network and serving one or more of the specified dosage formula(s) to the nutrition appliance during the session. Once received, the dosage formula(s) are locally stored at the nutrition appliance. The one or more dosage formula(s) can then be used to automatically produce the food product(s) at specific times or at the request of the individual.

In yet other non-exclusive embodiments, the personalized nutrition plan is generated from personalized nutrition data pertaining to the individual. The personalized nutrition data, which is typically uploaded by the individual to the server, may include one or more of the following a DNA test, a questionnaire completed by the individual, a wearable device worn by the individual, the body type of the participant, and/or information regarding the type of exercise, sporting activity or training performed by the individual. From the personalized nutrition data, meta-analysis is performed to generate the personalize nutrition plan, including one or more formula(s) for the food product(s) specific for the individual.

In yet additional embodiments, the method further involves creating a web site associated with an online nutrition-based community and enabling individuals, benefiting from the personalized nutrition, to participate in the community. Through one or more “dashboard” web page(s), an individual can participate in the community and track one or more personal metrics, including but not limited to, daily exercise, weight loss, strength, performance gains, calories burned, sleep, heart rate, performance vs. competition, and their intake of the nutrition ingredients, etc.

In yet another embodiment, a nutrition appliance is provided to the individual that includes one or more receptacles configured to receive the one or more nutritional ingredients. The network appliance also includes a network connection and memory configured to receive and store one or more of the personalized dosage formula(s). A controller, provided in the appliance, is configured to coordinate the transfer the specific amounts of the one or more nutritional ingredients, as specified by the one or more dosage formula(s), from the one or more receptacles to a mixing chamber, which mixes the ingredients to create the one or more food product(s). In a non-exclusive embodiment, the nutrition ingredients are each packaged in “pods” and the one or more receptacles are configured to receive the pods, each containing the one or more nutritional ingredients respectively.

In yet other non-exclusive embodiments, a transport mechanism, such as a robot or drone, is used to deliver the food product to the individual.

In yet other non-exclusive embodiments, a nutrition ecosystem is creating by providing a large network of nutrition service providers, each with one or more nutrition appliances. In such a network, the personalized food products would be generated for individuals members of the nutrition network at predetermined times or upon request from the individual(s) for either pickup or delivery to the individuals. Preferably, the personal food products would be generated by a provider that is local to the individual and based on the dosage formula(s) for each participating individual. By creating a large network of personal nutrition service providers, individuals may benefit from personalized nutrition no matter where they are located, regardless if they are close to home, the office or traveling. Furthermore, the personalized food products can be delivered by a robot butler, a drone, or other transport mechanism, or alternatively picked up by the individual at the local service provider.

### BRIEF DESCRIPTION OF THE DRAWINGS

The invention may best be understood by reference to the following description taken in conjunction with the accompanying drawings, which illustrate specific embodiments of the invention.

FIG. 1 is a diagram of a non-exclusive embodiment of an online community for determining and providing personalized nutrition for an individual in accordance with the principles of the present invention.

FIG. 2 is a non-exclusive embodiment illustrating the generation of a personalized nutrition plan from personal nutrition data received from the individual in accordance with the principles of the present invention.

FIG. 3 is an exemplary personalized nutrition plan in accordance with the principles of the present invention.

FIG. 4 is a non-exclusive embodiment of a nutrition appliance used by the individual in accordance with the principles of the present invention.

FIG. 5 is an exemplary web community “dashboard” computer display in accordance with the principles of the present invention.

FIGS. 6A and 6B are diagrams of two variations of a robot appliance “butler” in accordance with non-exclusive embodiments of the invention.

FIG. 7 is a flow chart for illustrating the steps for operating the robot nutrition appliance “butler” in accordance with a non-exclusive embodiment of the present invention.

FIG. 8 illustrates an example of the robot nutrition appliance butler in operation in accordance with a non-exclusive embodiment of the invention.

FIG. 9 is a flow chart illustrating the steps for the delivery of personalized nutrition food product(s) using drones in accordance with a non-exclusive embodiment of the present invention.

FIG. 10 is a diagram illustrating an exemplary example of using drones for the delivery of personalized nutrition products using drones in accordance with a non-exclusive embodiment of the present invention.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

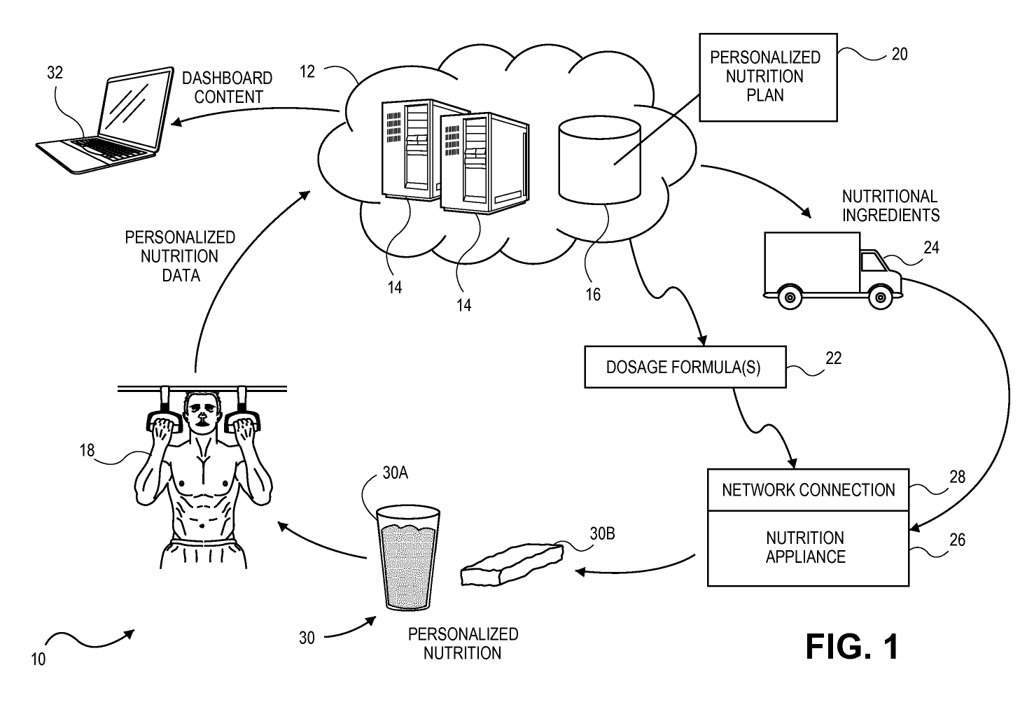

Referring to FIG. 1, a diagram of a non-exclusive embodiment of an online community 10 for determining and providing personalized nutrition is shown. The online community 10 is implemented by a computing infrastructure 12, including one or more servers 14 and a database 16, located on an electronic communication network, such as the Internet. The online community enables one or more individuals 18 to upload personal nutrition data to the server(s) 14. In response, a personalized nutrition plan 20, specific to the individual 18, is created and stored in the database 16. The personalized nutrition plan 20 specifies one or more dosage formula(s) 22, each specifying varying amounts of nutritional ingredients such as but not limited to vitamins, antioxidants, proteins, carbohydrates, minerals, extracts, electrolytes, energy supplements, and one or more flavor additive(s).

Once the dosage formula(s) is/are defined, the nutritional ingredients including the specified vitamins, antioxidants, proteins, carbohydrates, minerals, extracts, electrolytes, energy supplements, and one or more flavor additive(s) are delivered to the individual via a delivery service 24. The delivery service 24 may include any ground or air carrier such as the US Postal Service, FedEx, UPS, or an equivalent.

The dosage formula(s) 22 are electronically delivered to a nutrition appliance 26 associated with the individual 18 via a network connection 28 with the computing infrastructure 12. In various embodiments, the connection 28 may be a wired or wireless connection connecting the nutrition appliance 26 to the computing infrastructure 12.

In response, the nutrition appliance 26 generates one or more food product(s) 30 from (a) the plurality of nutritional ingredients shipped to the individual by the carrier 24 and (b) in accordance with the dosage formula(s) delivered over the electronic communication network. The food product(s) 30 may be either a liquid 30A, such as a smoothie or energy drink, or a solid 30B, such as an energy bar. The nutrition appliance 26 may be programmed to generate the food products 30 automatically at specific times in accordance with the personal nutrition plan 20 or at the request of the individual 18.

When the personalized nutrition plan 20 includes multiple different dosage formulas 22, each will specify different nutritional ingredients and/or varying amounts of the nutritional ingredients respectively. As a result, the food product 30 resulting from each dosage formula will vary in composition. For example, some food products 30 will have more protein and less carbohydrates than others. Alternatively, other food products 30 will have more carbohydrates and vitamins than others or an energy supplement, such as caffeine or a sleep aid, such as melatonin. In addition, any flavor added to the composition may vary. As a result, the food products 30 may have a variety of different flavors, such as cherry, apple orange, etc. It should be understood that by altering the dosage formulas 22, an almost infinite amount of compositions and/or flavors for the food products 30 may be created.

In one embodiment, the dosage formula(s) 22, and the resulting food product(s) 30, is/are optimized and intended for consumption based on a predetermined time of day. For example, food products 30 of different compositions may be consumed for specific meals, such as breakfast, lunch, dinner, snacks between meals, before bed, etc. In a second embodiment, the dosage formula(s) 22, and the resulting food product(s) 30, is/are optimized for a specific activity. Such activities may include, but are not limited to, training for a sport, just before participation in a sporting event, during the sporting event and in recovery following the sporting event. The dosage formula(s) 22 could, alternatively, also be developed to keep the individual energized throughout the day. For example, customized dosage formula(s) 22 can be developed as a morning wake-up, an afternoon pick-me-up, and an evening relax/unwind respectively.

The delivering of the dosage formula(s) 22 involves establishing one or more communication session(s) between the server(s) 14 and the nutrition appliance 26 over the communication network. During the session(s), the server(s) 14 access the database 16, retrieve the personalized nutrition plan 20 for the individual 18, and then serve one or more of the specified dosage formula(s) 22 to the nutrition appliance 26. The dosage formula(s) 22 may be served automatically at a designated time of day, automatically on one or more specified days, or in response to a request from the nutrition appliance 26. Regardless of the number of dosage formula(s) or the delivery schedule, the delivery involves using an IP address associated with the nutrition appliance 26. In various embodiments, the IP addressed may be fixed, or alternatively, dynamically assigned by the local network connecting the nutrition appliance 26 to the communication network.

The individual 18 interacts with the online community 10 using a communication device 32, such as a desktop computer, laptop computer, or a mobile communication device, such as a smart phone or a tablet computer. As is explained in more detail below, the individual 18 interacts with the online community through the communication device 32 to upload personal nutrition data to the computing infrastructure 12 and to track various metrics via a “dashboard” served by the server(s) 14.

For the sake of simplicity, FIG. 1 shows only a single individual 18. It should be understood, however, that a plurality of individuals 18 are intended to use and take advantage of the personalized nutrition provided by the online community and described herein. In each case, a personalized nutrition plan 20 is developed, and specific dosage formula(s) 22 are served, and nutrition ingredients are delivered 24, to a nutrition appliance 26, associated with each individual 18 respectively. In addition, each individual has the option to interact with the online community 10 via their own communication device 32.

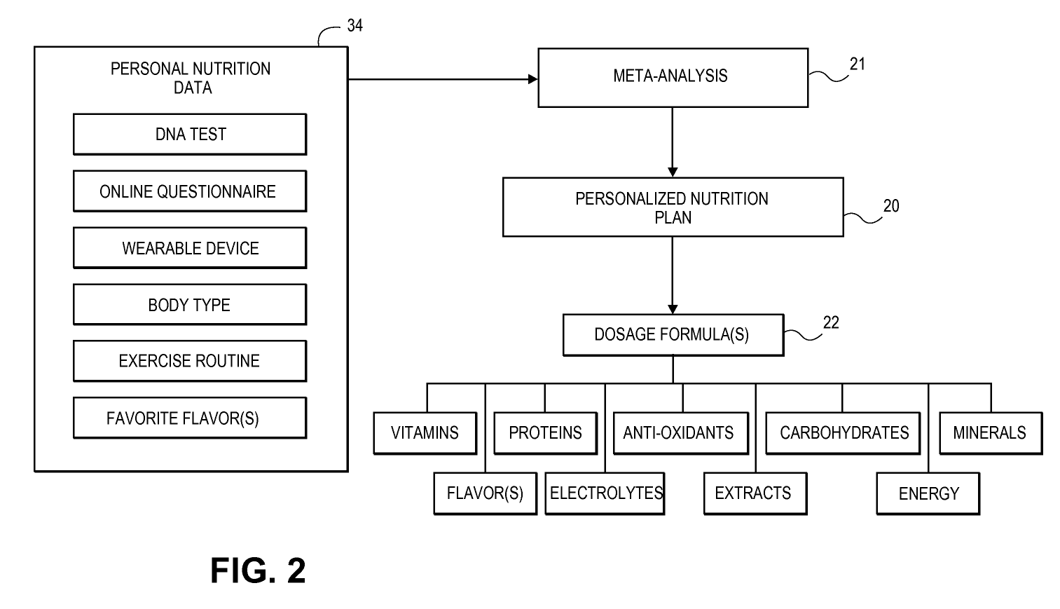

Referring to FIG. 2 a non-exclusive embodiment illustrating the development of the personalized nutrition plan 20 for an individual 18 is illustrated. In this embodiment, the individual 18 uploads personal nutrition data 34 to the server(s) 14. Such personal nutrition data may include, but is not limited to, a DNA test, answers from a questionnaire designed to elicit (i) the goals and/or objectives of the individual 18, (ii) the body type of the individual 18, (iii) the exercise routine and/or training regiment of the individual, and (iv) the favorite flavor(s) of the individual. In addition, other personal nutrition data generated by a wearable device, such as a pedometer or a “sports” watch, may also uploaded to the server(s) 14. In response, the personalized nutrition plan 20 is created for the individual 18. In a non-exclusive embodiment, the personalized nutrition plan 20 may be created using meta-analysis, which is a statistical survey and examination of the uploaded personal nutrition data 34 of both the individual 18 as well as statistical trends, studies and information regarding other individuals 18, athletes, and the public at large, regarding nutrition, weight loss, athletic performance, etc. By applying meta-analysis, a personalized nutrition plan, including one or more dosage formula(s) 22, may be specified for the individual 18. As noted above, the personalized nutrition plan 20 typically entails one or more dosage formula(s) 22, each containing different amounts of nutrition ingredients (e.g., vitamins, antioxidants, proteins, carbohydrates, minerals, extracts, electrolytes, energy supplements, and one or more flavor additive(s)).

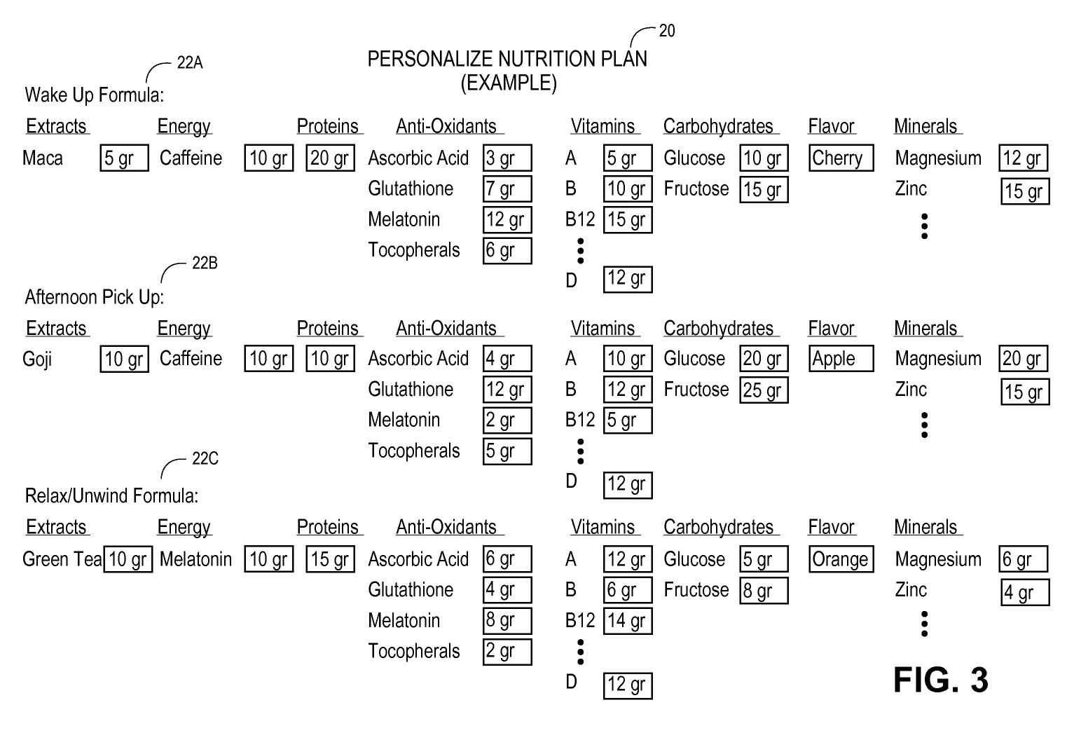

Referring to FIG. 3, an exemplary personalized nutrition plan 20 for individual 18 is shown. In this example, different dosage formulas 22A, 22B and 22C are shown for a morning “wake-me-up” formula, an afternoon “pick-me-up” formula, and an evening relax/unwind formula respectively. In each case, one or more ingredients, including vitamins, antioxidants, proteins, carbohydrates, minerals, extracts, electrolytes, energy supplements, and their amounts (in grams), are specified. In addition, a preferred flavor is used in each for variety and to make sure the food product 30 tastes good to the individual 18. In various embodiments, the individual may specify the flavors. Alternatively, suitable flavors for the individual 18 can be determined using the DNA test results, a questionnaire or a flavor panel test.

The actual ingredients and amounts for each dosage formula 22A, 22B and 22C as shown in FIG. 3 are merely for illustrative purposes. It should be understood that the list of nutrition ingredients, and their amounts, typically varies for each individual 18, their specific DNA, and their current situation and goals. For example, the dosage formula(s) for producing the food product(s) 30 differ depending on DNA, the body type and objectives of the individual 18. The dosage formula(s) 22 will be different for those trying to lose weight versus gaining muscle mass, endurance versus speed, strength versus flexibility, etc. The dosage formula(s) 22 may also be tailored for specific activities. For example, the food products 30 may be formulated for training, the day before a sporting event, the day of the sporting event, and/or for a speedy recovery of the individual 18 after the sporting event. For instance, the food product 30 will typically have higher carbohydrate content for endurance athletes (e.g., a marathon runner) versus a power athlete (e.g., a weight lifter), who will benefit from a food product 30 having higher protein content. The ingredient composition of each dosage formula 22 is also likely to vary depending on the time of day the resulting food product 30 is likely to be consumed. For example, the wake-me-up and pick-me-up formulas 22A and 22B are likely to include an energy additive, such as caffeine, while the evening relax/unwind formula 22C is likely to include sleep aid ingredients, such as melatonin or L-theanine.

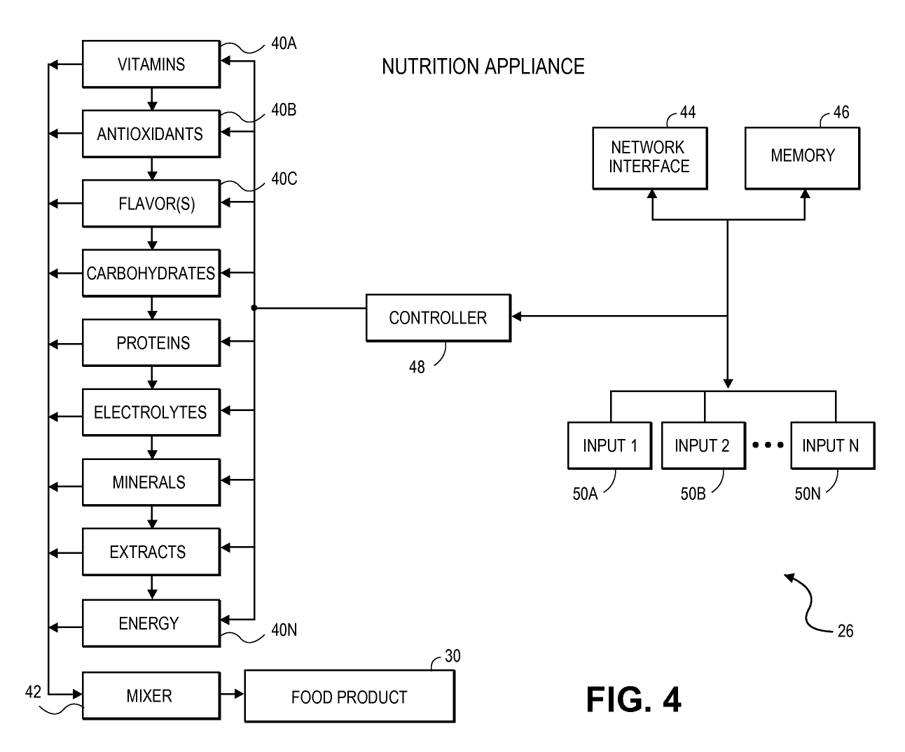

FIG. 4 is a non-exclusive embodiment of the nutrition appliance 26 provided to and used by the individual 18. The nutrition appliance 26 includes a plurality of receptacles 40A through 40N for receiving the nutrition ingredients and flavor(s) and a mixer 42 for mixing the ingredients and flavor. The nutrition appliance 26 also includes a network interface 44 for establishing the network connection 28 with the computing infrastructure 12 via a communication network, such as the Internet, a memory 46 for storing an IP address, which is used to identify the network appliance 28 on the communication network. The memory 44 is also provided to store the dosage formula(s) 22 received from the computing infrastructure 12. A controller 48, which is coupled the receptacles 40A-40N, the mixer 42, the network interface 44 and the memory 46, and a number of inputs 50A through 50N, is also provided. The controller 48 is responsible for controlling the operation of the nutrition appliance 28. As is well known in the art, the nutrition appliance is capable of generating food products 30, in either liquid 30A or solid form 30B, as for example described in US Publication 2006/0081653, incorporated by reference herein.

In non-exclusive embodiments, each of the nutrition ingredients and flavor are shipped to the individual in “pod” containers and the receptacles 40A through 40N are each designed to receive the pods respectively. The network interface 44 can be either a wired or a wireless network connection. The IP address, identifying the network appliance 26 on the communication network, can be a fixed IP address or a dynamic IP address. Finally, the inputs 50A-50N enable the user to control the operation of nutrition appliance 26. The inputs 50 may include, for example, an on/off switch, controls for connecting the nutrition appliance 26 to a local network, and for inputting instructions to the nutrition appliance 26, such as when to retrieve the dosage formula(s) from the from the computing infrastructure 12, when to generate the food products (30), and user preferences such as either liquid 30A or solid 30B food product, flavors, etc.

The controller 48 of the nutrition appliance 26 periodically establishes a communication session with the server(s) 14 over the communication network via the network interface 44. During the session, the server(s) 14 retrieve from database 16 one or more dosage formula(s) 22 in accordance with the personalized nutrition plan 20 developed for the individual 18. In various embodiments, the sessions may be established, and the dosage formula(s) 22 served, (i) automatically at a designated time of day, (ii) automatically on one or more specified days, or whenever the nutrition appliance 28 establishes a session and requests the dosage formula(s). Regardless of the number of dosage formula(s) 22, the delivery involves, electronically transmitting the one or more dosage formula(s) 22 from the server(s) 14 to the nutrition appliance 26 using the IP address associated with the nutrition appliance 26. Once received, the dosage formula(s) 22 are stored in the memory 44 for later access by the controller 48 when a food product 30 is to be produce.

The online community 10 is another beneficial aspect for the individual 18. The computing infrastructure 12, including the server(s) 14 and the database 16, is used to create a nutrition-based, on-line, “ecosystem” where a plurality of individuals 18 can each log into the system using their communication devices 32, share nutrition, training and exercise information with other participants 18, and track their personal progress and their progress versus others. In one embodiment, the individual 18 may participate in the community via a “dashboard” display on their communication devices 32.

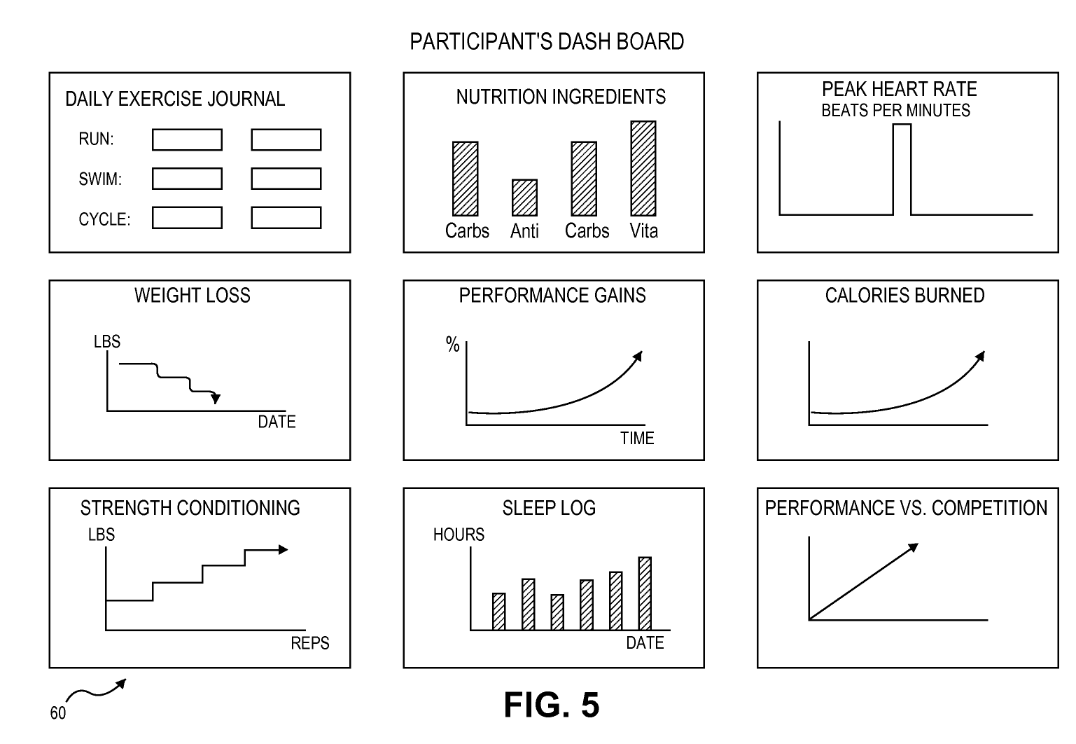

Referring to FIG. 5, an exemplary display dashboard 61 in accordance with the principles of the present invention is shown. Through this dashboard 61, the individual 18 may upload information and track one or more personalized metrics, such as daily exercise, weight loss, strength, performance gains, calories burned, sleep, heart rate, performance vs. competition and intake of the nutrition ingredients. It should be noted that the metrics illustrated in FIG. 5 are merely illustrative and should not be construed as limiting in any manner. On the contrary, any information pertaining to a personal metric, health, nutrition, exercise, sport training, or other activity, may be included in the dashboard. The dashboard 61 may be accessed and displayed by the individual through the display of any computer, including desktop, laptop or mobile communication devices, such as cell phones, tablet computers, or the like.

### Robot Appliance Butler

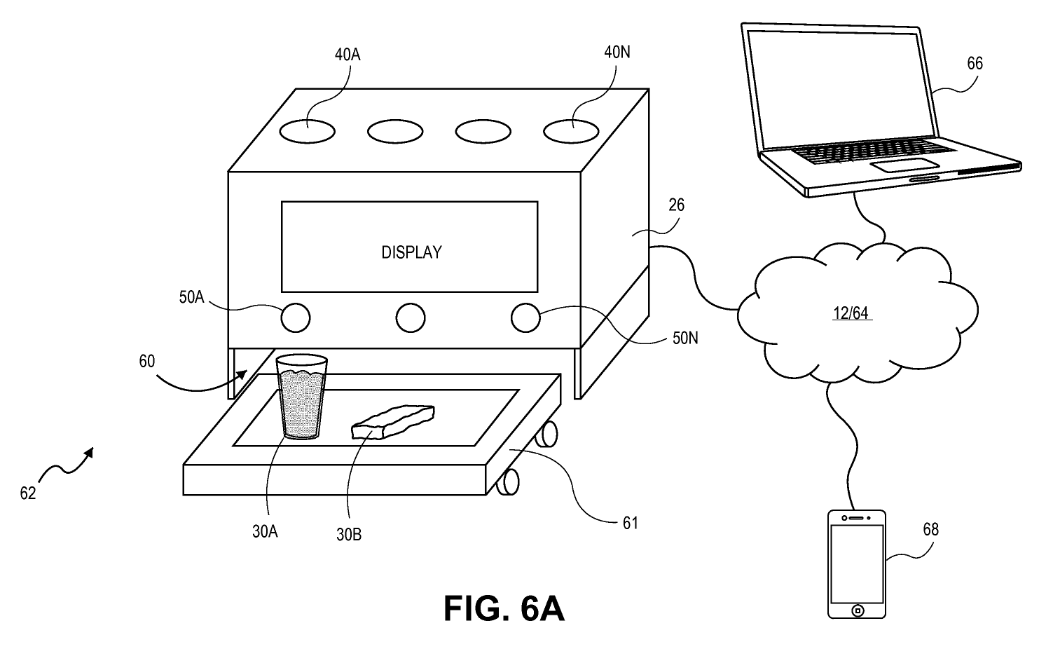

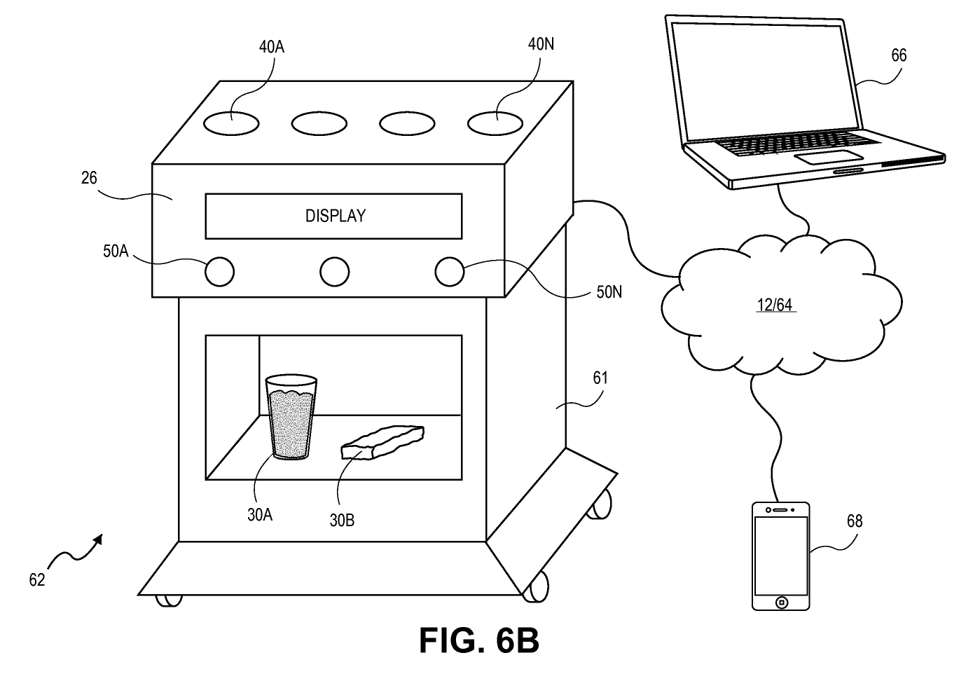

Referring to FIG. 6A, a diagram of a robot appliance “butler” in accordance with a non-exclusive embodiment of the present invention is illustrated. In this embodiment, the nutrition appliance 26 is modified to include a docking station 60 for docking a robot 61. Together, the nutrition appliance 26 and the robot 61 cooperate to provide a robot appliance ‘butler” 62 that is capable of (i) generating a personalized food product 30, including either a liquid 30A and/or a solid 30B food product, for an individual 18 as described above and then (ii) the robot 61 delivers the food product 30 to the individual 18 at a location remote from the robot appliance butler 62.

Referring to FIG. 6B, another embodiment of a robot appliance butler 62 is illustrated. This embodiment is similar to that illustrated in FIG. 6A, except the nutrition appliance 26 and the robot 61 are integrated into a single mobile device. In other words, the robot appliance butler 62 of FIG. 6B, including the nutrition appliance 26, is capable of traveling to an individual 18 and delivering a previously generated food product 30 or generating a food product on the spot after arriving at the location of the individual 18.

With either embodiment of FIGS. 6A and/or 6B, an individual 18 may communicate with the robot appliance butler 62 using either a computer 66 and/or a cell phone via the computing infrastructure 12 and/or a local WiFi network 64. In either case, the individual may upload personal nutrition data 34, as described above, and may also enter commands for the robot appliance butler 62. For example, if the individual 18 is feeling hungry, or is about to engage in rigorous exercise, then commands can be entered directing the robot appliance butler to generate either a personalized food product 30 or a non-personalized food product and deliver it to the individual on the spot. In addition, with inputs 50A through 50N and a display screen provided on the nutrition appliance 26, an individual 18 is able to interact with the robot appliance butler of either FIG. 6A and/or FIG. 6B. For example, the display could be used to display the personal nutrition data 34 of the individual, the dosage formula(s) 22 of the individual 18, or the dashboard information of FIG. 5 for example belong to or associated with the individual 18.

In alternative embodiments of FIGS. 6A and 6B, the food product delivered to the individual 18 does not necessarily have to be personalized for the individual 18, but rather, can be a generic food product that is produced by the nutrition appliance 26, similar to commercially available energy bars and/or drinks Regardless of the embodiment, the food product is generated from ingredients provided in the receptacles 40A through 40N. Using inputs 50A through 50N, the individual 18, or another person, may control the operation of the robot appliance butler 62, including both the nutrition appliance 26 and the robot 61.

In accordance with a non-exclusive embodiment, the robot 61 of the robot appliance butler 62 of either FIGS. 6A and 6B is a programmable robot that is: (i) capable of mapping a location, such as the home of the individual 18, (ii) capable of navigating the mapped location and (iii) programmable to deliver the food products, either customized or not customized, to the individual 18, at designated times, and at designated space(s) within the mapped location. For example, the robot 61 may use well-known robot technology as used in commercially available robot products, such as the Hom-Bot vacuum cleaner offered by LG, Neoto Robotics XV-21, or the Roomba 880 or similar products, such as the iRobot AVA robot. In other words, the robot 61 is capable of learning its way around the location, such as the house of the individual 18, navigating to specific spaces within the location (e.g., a bedroom, home office, home gym, etc), travelling down hallways and up and/or down stairs, navigating through different rooms, etc., and programmable to deliver food products, either customized or not, at designated times to designated space(s) within the location.

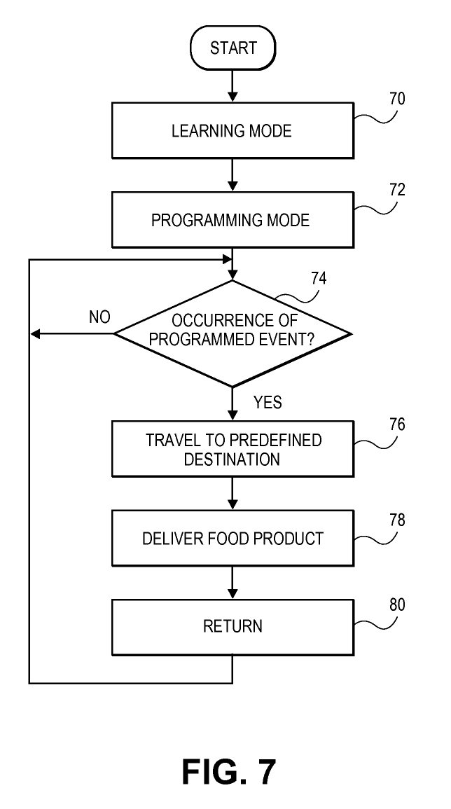

Referring to FIG. 7, a flow chart for illustrating the steps for operating the robot nutrition appliance butler 62 of both FIGS. 6A and 6B in accordance with a non-exclusive embodiment of the present invention is shown. In this embodiment, the initial step 70 involves a learning mode where the robot 61 leans to navigate a designated location, such as the house of the individual 18. In this process, the robot 61 is typically allowed to roam the location, digitally mapping spaces within the location as the robot 61 discovers the boundaries of each room and the layout of each room in the house. In step 72, the robot appliance butter 62 is programmed. In this step, the appliance 26 is programmed to generate the personalized food products 30A and/or 30B at designated times of the day. Alternatively, the appliance 26 can also be programmed to generate non-personalized food product(s) at specified times of the day. The robot 61 is also programmed to deliver the food product(s), after they are generated, to a designated space within the location. In an extension of the above example, the nutrition butler 62 may be programmed to generate and deliver the wake-me-up food product 30 to the bedroom of the individual 18 at 7 AM, the pick-me-up food product 30 to the home office of the individual 18 at 3 PM, and the relax/unwind formula to the bedroom at 9 PM. In step 74, the appliance butter 62 continually monitors to determine if a programmable event has occurred. If yes, then the robot 61 travels to the designated space at the designated time (step 76), delivers the food product(s) (step 78), and then returns (step 80) to the docking station 60.

In variations of step 70, the robot 61 can also be programmed to learn to navigate multiple locations, such as the office, main home, second or vacation home, and other locations frequented by the individual(s) 18. In variations of step 72, the nutrition appliance butler 62 can be periodically reprogrammed to update the dosage formula(s) of the personalized food products 30A and/or 30B or non-personalized food product. The times and/or spaces for delivery can also be programmably changed. In addition, nutrition appliance butler 62 may be programmed for multiple individuals 18.

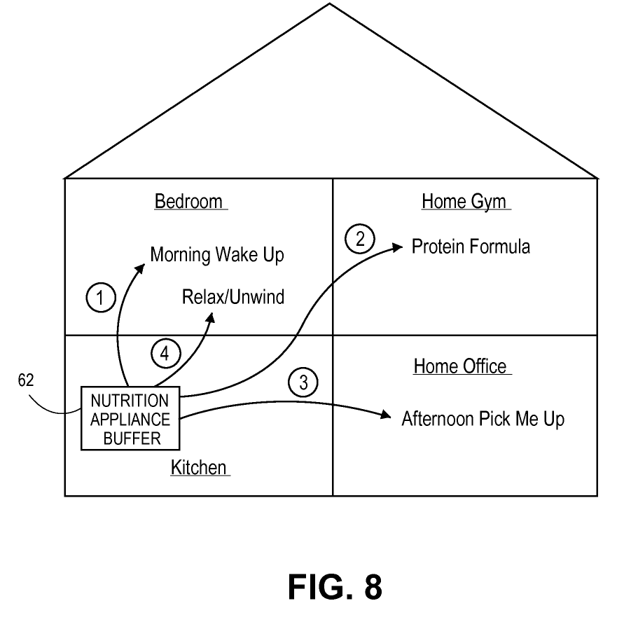

Referring to FIG. 8 an example of the robot nutrition appliance butler 62 of FIGS. 6A and 6B in operation within the house of an individual 18 is illustrated. In this illustrative example, the robot 61 makes four trips during the course of a day. For delivery “1”, a wake-me-up food product is delivered to the bedroom at 7 AM. For delivery “2”, a high protein food product is delivered to a home gym at 10 AM. For delivery “3”, an afternoon pick-me-up food product is delivered to the home office. Finally, for delivery 4, the relax/unwind formula food product is delivered to the bedroom. Again, each food product may be personalized or not personalized.

The example of FIG. 8 is meant for illustrative purposes only and should not be construed as limiting in any manner. It should be understood that the nutrition appliance butler 62, as described herein, could be used in an almost unlimited number of situations and settings. For example, the nutrition appliance can be used in the office, in any public and/or private building or location, a home gym or sports club or spa, at sporting events for both participating athletes and/or fans, etc.

### Delivery Using Drones

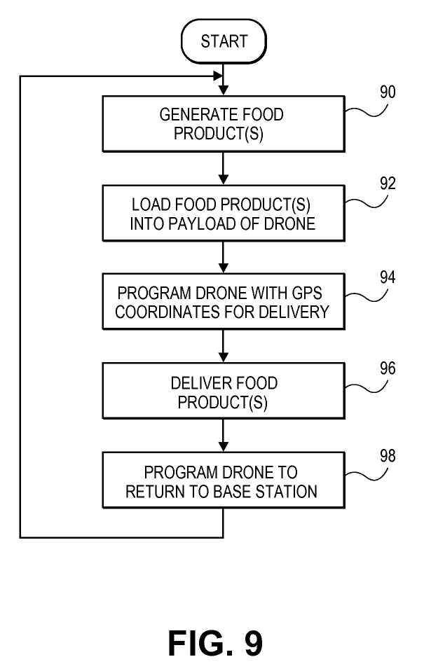

FIG. 9 is a flow chart illustrating the steps for the delivery of personalized nutrition food product(s) using drones in accordance with a non-exclusive embodiment of the present invention. In step 90, the nutrition appliance 26 generates the food product(s). Again, the personalized food product(s) may be customized for a specific individual or they may be generic food product(s). In step 92, the food product(s) are loaded in the payload of a drone. In step 94, the drone is programmed with the GPS coordinates for delivering the food products. It should be noted that the drones could be programmed on the spot after the nutrition appliance 26 generates the food product(s) or GPS coordinates can be pre-programmed. In step 96, the drone delivers the food product(s) to one or more individuals located at the designated GPS coordinate. Once the food product(s) are delivered, the drone returns to a base station in step 98.

In a non-exclusive example of the FIG. 9 embodiment, an “ecosystem” for generating and delivering personalized nutrition may implemented using the principles described herein. In such an ecosystem, many individuals 18, each with their own personal nutrition plan 20 with one or more dosage formula(s) 22, are invited to join an online nutrition-based community including a network of nutrition service providers. For each individual 18 of the community, the nutrition plan 20 and dosage formula(s) 22 are stored in the database 16 of the computer infrastructure 12. In addition, a number of nutrition service providers (e.g., base stations), such as local food-related merchants or shops, also belong to the nutrition ecosystem and maintain one or more the nutrition appliance(s) 26. In such a nutrition ecosystem, the individuals 18 may elect to have personalized nutrition products 30A/30B generated by a nutrition appliance 26 located at a local nutrition service provider at designated time(s) or upon request. For example, an individual 18, using their computing device 32, such as a computer, may request that personalized food product(s) 30A/30B be created at a designated time or times of the day (e.g., for breakfast, lunch, afternoon snack, etc.). Alternatively, the individual 18 can get online, access the computing infrastructure 12, and request that a food product 30A/30B at a specified time. In either case, the nutrition appliance 26 at the local service provider is programmed or otherwise receives instructions from the infrastructure 12 to generate the food product 30A/30B at the designated time or upon request respectively. Further with this embodiment, the food product 30A/30B can then be picked up by the individual 18, or alternatively, delivered to the individual, via either a delivery vehicle, a robot appliance, or by drone for example. With a robot appliance or drone used as the delivery mechanism, both would be programmed to return to its base station (i.e., the location of the originating nutrition appliance or some other designated location) after the delivery. With many nutrition service providers located at different locations, a nutrition ecosystem or network is created that is capable of providing personalized nutrition too many individuals 18 located at a wide variety of locations, including close to their home or office, or when they travel.

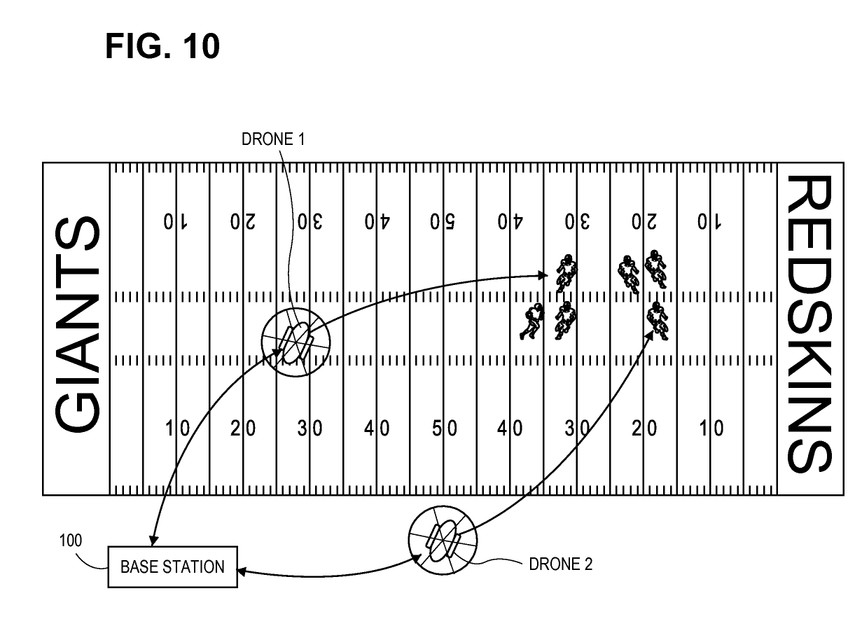

Referring to FIG. 10, another embodiment illustrating the use of drones (Drone 1 and Drone 2) to opposing teams during a sporting event is illustrated (e.g., a football game in this example). For example during a TV commercial break during the game, Drones 1 and/or Drone 2 may be loaded with personalized food products 30A and/or 30B or non-personalized food product(s) at a base station 100. The nutrition appliance 26 that generates the food products, either personalized 30 or non-personalized, may be located either at the base station 100 or at a location remote from the base station 100, such as (but not limited to) a locker room in this example. When loaded, the drones then deliver the food product(s) to the players on the field. After the delivery, the drones return to the base station 100. This process may be repeated multiple times during the course of the game.

It should be noted that the drones do not necessarily have to rely on GPS coordinates to deliver food product(s). In alternative embodiments, the drones can be controlled using a wireless remote controller for example. If the football game illustrated in FIG. 10 were conducted in a domed stadium for example, the latter embodiment would be beneficial, as GPS often does not work within enclosed buildings. It should also be noted that the nutrition appliance 26 may or may not be located at the drone base station 100. In embodiments where the nutrition appliance 26 is located at the based station 100, food product(s) can be generated on the spot and then delivered using the drones to players on the field. Alternatively, the nutrition appliance 26 can be located at another location, such as in a team locker room and the generated food product(s) may be carried to the base station 100 for delivery to the players on the field.

It should also be noted that the football game depicted in FIG. 10 should in no way be construed as limiting the application of using drones for the delivery of food product(s). In various implementations, the nutrition appliance 26 and the drones may be used for the delivery of food products in a wide variety of settings, including indoor and outdoor sporting events, musical events, public gatherings, or in just about any situation where an individual 18 is in a location remote from a nutrition appliance 26.

Finally, the robot 61 of the robot appliance butler 62 of FIGS. 6A and 6B and the drones of FIGS. 9 and 10, are just two non-exclusive embodiments of transport mechanisms that could be use to deliver food product, both personalized 30A/30B and non-personalized, to individuals 18. It should be noted, however, that any transport mechanism may be used.

Although many of the components and processes are described above in the singular for convenience, it will be appreciated by one of skill in the art that multiple components and repeated processes can also be used to practice the techniques of the system and method described herein. Further, while the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and should not be restricted to the ones mentioned above. It is therefore intended that the invention be interpreted to include all variations and equivalents that fall within the true spirit and scope of the invention.

What is claimed is:

1. A method, comprising:
generating a personalized nutrition plan for an individual;
specifying a dosage formula for the individual based on the personalized nutrition plan, the dosage formula specifying a plurality of nutritional ingredients;
delivering the dosage formula to a nutrition appliance over an electronic communication network;
providing the plurality of nutritional ingredients for use in the nutrition appliance;
configuring the nutrition appliance to generate a food product from:
(a) the plurality of nutritional ingredients provided to the individual for use in the nutrition appliance; and
(b) in accordance with the dosage formula delivered over the electronic communication network; and
relying on a transport mechanism to transport the food product to the individual.

2. The method of claim 1, wherein the dosage formula specifies one or more of the following nutritional ingredients:
(a) vitamins;
(b) an antioxidant;
(c) a protein;
(d) a carbohydrate;
(e) a mineral,
(f) an extract,
(g) an electrolyte,
(h) an energy supplement, and
(i) a flavor additive.

3. The method of claim 1, wherein the dosage formula specifies the amount of each of the plurality of nutritional ingredients respectively.

4. The method of claim 1, wherein the personalized nutrition plan specifies multiple dosage formulas, each of the multiple dosage formulas resulting in multiple food products having different compositions of the plurality of nutritional ingredients respectively.

5. The method of claim 4, wherein each of the multiple food products are intended for consumption by the individual at a predetermined time of day respectively.

6. The method of claim 5, wherein the predetermined time of the day includes one of the following:
(a) breakfast;
(b) lunch;
(c) dinner;
(d) between meals; or
(e) before bed.

7. The method of claim 4, wherein each of the multiple food products are intended for consumption by the individual in anticipation of an activity by the individual.

8. The method of claim 7, wherein the activity performed by the individual includes one of the following:
(a) training for a sport activity;
(b) just before participation in a sporting event;
(c) during the sporting event;
(d) in recovery following the sporting event; or
(e) before bed.

9. The method of claim 4, wherein each of the multiple food products is formulated for a specific objective.

10. The method of claim 9, wherein the specific objective includes one of the following:
(a) wake-me-up;
(b) pick-me-up; or
(c) relax/unwind.

11. The method of claim 1, wherein the delivering of the dosage formula to the nutrition appliance over the electronic communication network further comprises:
establishing a communication session between a server and the nutrition appliance over the communication network; and
serving the dosage formula to the nutrition appliance during the session.

12. The method of claim 10, further comprising serving a plurality of dosage formulas during the session.

13. The method of claim 1, further comprising:
receiving personalized nutrition data pertaining to the individual; and
generating the personalized nutrition plan from the personalized nutrition data pertaining to the individual.

14. The method of claim 13, wherein the personalized nutrition data comprises one or more of the following:
(a) a DNA test;
(b) a questionnaire
(c) a wearable device;
(d) body type of the individual; and
(e) type of exercise performed by the individual.

15. The method of claim 13, further comprising generating the personalized nutrition plan by performing meta-analysis on the personalized nutrition data.

16. The method of claim 1, wherein providing the plurality of nutritional ingredients further comprises:
packaging each of the plurality of nutritional supplements in individual containers respectively;
shipping the individual containers to a location where the nutrition appliance is located.

17. The method of claim 16, wherein each of the individual containers is a pod designed for insertion into a receptacle provided in the nutrition appliance.

18. The method of claim 1, wherein configuring the nutrition appliance to generate the food product further comprises:
receiving the plurality of nutritional ingredients in a plurality of receptacles provided in the nutrition appliance respectively;
transferring specified amounts of the plurality of nutritional ingredients, in accordance with the specified dosage formula, from the plurality of receptacles to a mixing chamber; and
producing the food product by mixing the transferred plurality of nutritional ingredients in the mixing chamber.

19. The method of claim 1, wherein the food product comprises either a liquid or a solid food product.

20. The method of claim 1, wherein the food product comprises a beverage a bar, cereal, a cracker or a chip.

21. The method of claim 1, further comprising creating a web site associated with online nutrition-based community, the web site enabling the individual to participate in the online nutrition-based community through the web site.

22. The method of claim 21, further comprising receiving from the individual through the web site personal nutrition data used to generate the personalized nutrition plan.

23. The method of claim 21, wherein the online nutrition-based community enables the individual to track one or more personal metrics, including:
(a) daily exercise;
(b) weight (BMI)
(c) strength;
(d) performance gains;
(e) calories burned;
(f) sleep;
(g) heart rate;
(h) performance vs. competition;
(i) intake of the nutrition ingredients;
(j) body mass index (BMI); and
(e) a metrics comparison with other individuals of the online nutrition-based community.

24. The method of claim 1, wherein the transport mechanism is a robot.

25. The method of claim 24, wherein the robot and the nutrition appliance are integrated into a single mobile device.

26. The method of claim 24, wherein the robot is configured to roam separately from the nutrition appliance.

27. The method of claim 1, wherein the transport mechanism is a drone.

28. A robot appliance, comprising:
a nutrition appliance including:
(a) one or more receptacles configured to receive one or more nutritional ingredients;
(b) a network connection configured to receive a personalized dosage formula for an individual, the personalized dosage formula specifying specific amounts of each of the one or more nutritional ingredients; and
(c) a mixing chamber configured to mix the specific amounts of each of the one or more nutritional ingredients in accordance with the dosage formula to create a food product personalized for the individual; and
a robot, associated with the nutrition appliance, the robot configured to deliver the food product to the individual.

29. The robot appliance of claim 28, wherein the robot and the nutrition appliance are integrated into a single mobile device.

30. The robot appliance of claim 28, wherein the nutrition appliance includes a docking station for docking the robot which is configured to deliver the food product to the individual.

31. The robot appliance of claim 29, wherein the food product is a liquid food product or a solid food product.

32. The robot appliance of claim 28, wherein the one or more receptacles are configured to receive one or more pods each containing the one or more nutritional ingredients respectively.
